(19) United States
(12) Patent Application Publication
(10) Pub. No.: US 2010/0107910 A1
(43) Pub. Date: May 6, 2010

(54) PRINTING TOWERS COMPRISING AT LEAST TWO SUPERIMPOSED PRINTING GROUPS, AND METHOD FOR THE OPERATION OF SUCH A PRINTING TOWER

(76) Inventors: Christian Arnold, Rimpar (DE); Christoph Alfons Schmitt, Dittelbrunn/Hambach (DE)

Correspondence Address: JONES, TULLAR & COOPER, P.C., P.O. BOX 2266 EADS STATION, ARLINGTON, VA, 22202, US

(21) Appl. No.: 12/451,709

(22) PCT Filed: Aug. 8, 2008
(86) PCT No.: PCT/EP2008/060456

§ 371 Date: Nov. 25, 2009

(30) Foreign Application Priority Data
Sep. 27, 2007 (DE) 10 2007 000 783.5
Oct. 31, 2007 (DE) 10 2007 000 604.9

(51) Int. Cl. B41F 5/16; B41L 1/02

(52) U.S. Cl. 101/183; 101/485

(57) ABSTRACT

A printing tower is comprised of at least two superimposed printing groups and at least two lateral frames A distance between the two lateral frames can be varied in a horizontal direction. Each of these two lateral frames accommodates at least two of the superimposed printing groups. At least one of the two lateral frames can be moved horizontally between a functional position, in which the lateral frames adjoin each other; and an open position in which the two lateral frames are spaced apart from each other. An elevating platform is situated between the two lateral frames when they are in their open position. The elevating platform can be lowered into a bottom resting position so that the two frame sets can be moved into their closed functional position.

### CROSS REFERENCE TO RELATED APPLICATIONS

This application is the U.S. national phase, under 35 U.S.C. 371, of PCT/EP2008/060456, filed Aug. 8, 2008; published as WO 2009/043628 A2 and A3 on Apr. 9, 2009 and claiming priority to DE 10 2007 000 783.5, filed Sep. 27, 2007 and to DE 10 2007 000 604.9, filed Oct. 31, 2007, the disclosures of which are expressly incorporated herein by reference.

### FIELD OF THE INVENTION

The present invention is directed to printing towers with at least two printing couples arranged one above the other, and is also directed to a method of operating such a printing tower. The printing tower has two side frames whose spacing distance can be changed in a horizontal direction. An elevatable lifting platform is situated between the two side frames. The lifting platform can be elevated when the side frames are moved apart horizontally and can be lowered before the side frames are moved back to their closed, functional position. A safety device is usable to form a boundary around a passage space between the side frames when they are in the open, horizontally spaced position.

### BACKGROUND OF THE INVENTION

A printing tower, with at least two printing couples which are arranged one above the other, is known from WO 2004/080718 A1. This printing tower has at least one lifting platform which is usable for transporting operating technicians to different heights in the printing tower. These correspond to the different heights at which printing couples are arranged in the printing tower.

DE 198 33 468 A1 discloses a printing tower with two frame halves that can be separated horizontally from one another. When the printing tower is in this separated, horizontally opened state, a working platform, which can be raised and lowered, is situated between the halves of the frame. This prior art documents provides no details as to the location of the working platform, especially when the frame is closed.

A printing tower, with multiple printing couples arranged one above the other, is known from DE 94 21 112 U1. The printing couples are mounted in side frames, which side frames can be displaced, relative to one another, in a horizontal direction.

US 2004/0182271 A1 describes a printing press with a lifting platform that can be moved between the side frames.

### SUMMARY OF THE INVENTION

The object of the present invention is to provide printing towers each having at least two printing couples which are arranged one above the other, and to provide a method of operating such printing towers.

The object is attained according to the present invention by providing a printing tower having at least two printing couples arranged one above the other. The printing tower is comprised of at least two side frames or side frame assemblies which are separable horizontally. Each such side frame assembly accommodates at least two of the vertically spaced printing couples. An elevatable lifting platform is situated between the horizontally separable side frame assemblies and can be elevated when the side frame assemblies are spaced horizontally apart. The lifting platform can be lowered to allow the side frame assemblies to be moved together into their closed, functional position. A safety device is usable to form a boundary around a passable space between the side frame assemblies when they are in their open position.

A printing tower is provided with at least two printing couples that are arranged one above the other and with at least one lifting platform. The lifting platform is preferably usable for transporting operating technicians to different heights corresponding to the different heights at which the vertically arranged printing couples are arranged the printing tower is equipped with at least two side frames or side frame assemblies, the distance between which can be adjusted in a horizontal direction. Each such side frame assembly can accommodate at least two printing couples which are arranged vertically one above the other, or can accommodate parts of at least two such printing couples arranged one above the other, such as, for example, plate cylinders and/or transfer cylinders and/or inking units and/or dampening units. At least one of the side frames or side frame assemblies can be moved generally horizontally between a functional position, in which the side frames adjoin one another, and an opened position, in which they are spaced from one another. One of the lifting platforms is arranged between the two side frames and is elevatable when they have been moved to their opened position.

The benefits to be achieved in accordance with the present invention consist especially in that the side frames, which are provided with adjustable spacing, enable particularly good access to the parts of the printing couples that are typically located in the interior of the printing tower, thus making maintenance and inspection work easy to perform and to supervise. With the lifting platform arranged between the side frames in the opened position, maintenance and inspection work on the interior of the printing tower can be performed ergonomically and efficiently. Operating personnel can use the elevatable lifting platform to easily access the upper components of the vertically stacked printing couples.

In accordance with the present invention the configuration of the printing tower and of the lifting platform is simple. This is especially true since the lifting platform does not need to be moved, except for its vertical lifting motion. The lifting platform remains recessed between the side frames when not in use. In an uncomplicated manner, the idle position of the lifting platform is located below the movable side frames. This idle position of the lifting platform is especially at least below the bottom transfer cylinder, and advantageously is below the bottom transfer cylinder and the bottom forme cylinder.

In an alternative or supplementary embodiment of the present invention, a safety device, and preferably a guard rail section, is provided for use in for enhancing the safety of personnel. This guard rail section is preferably arranged between the two side frames or side frame assemblies which are movable in relation to one another.

### BRIEF DESCRIPTION OF THE DRAWINGS

A preferred embodiment of the present invention is represented in the accompanying set of drawings and will be specified in greater detail in what follows. The drawings show:

FIG. 1 a schematic side elevation representation of a printing tower with side frames, the distance between which can be adjusted in a horizontal direction, in a functional position from a side view, with a lifting platform, which is depicted in dashed lines, being arranged between the two side frames and being elevatable when the two in their opened position;

FIG. 2 a schematic side elevation representation of the printing tower of FIG. 1, simplified such that inking and dampening units, and plate and transfer cylinders of the printing couples, are not shown;

FIG. 3 the printing tower of FIG. 2 with the side frame assemblies separated horizontally and with the lifting platform depicted schematically in its lower, idle position;

FIG. 4 a perspective representation of the printing tower of FIG. 3;

FIG. 5 a schematic side elevation representation of the printing tower of FIG. 3 with the lifting platform shown in a raised, working position;

FIG. 6 a perspective representation of the printing tower of FIG. 5;

FIG. 7 a schematic side elevation view of a lifting platform configured as a scissor lift, and arranged between the two side frames, which are not specifically shown, and which are in their opened position;

FIG. 8 an exploded, perspective view of the lifting platform of FIG. 7;

FIG. 9 a schematic side view of a lifting platform which is configured as an elevator, and which is arranged between the two side frames, which are in their opened position.

### DESCRIPTION OF THE PREFERRED EMBODIMENT

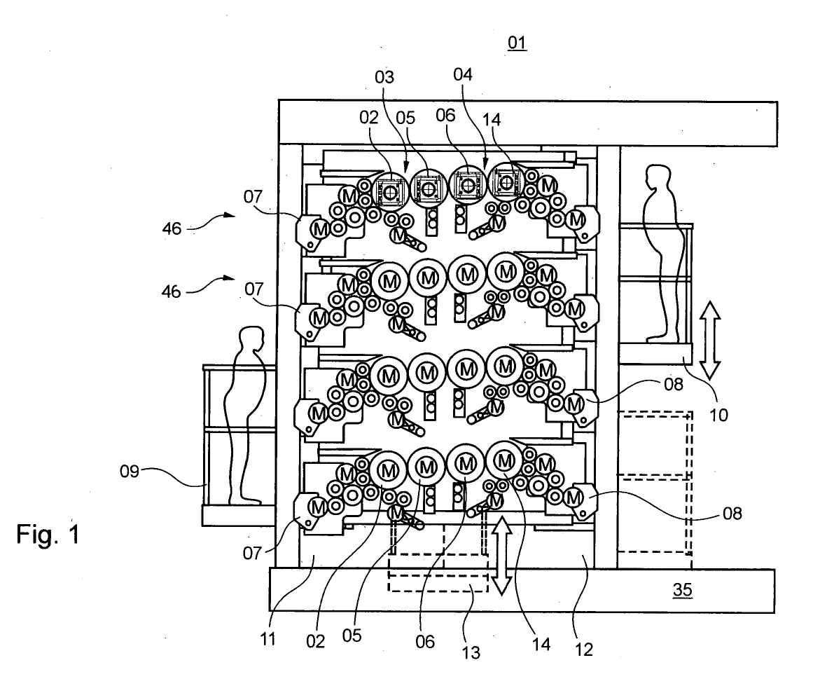

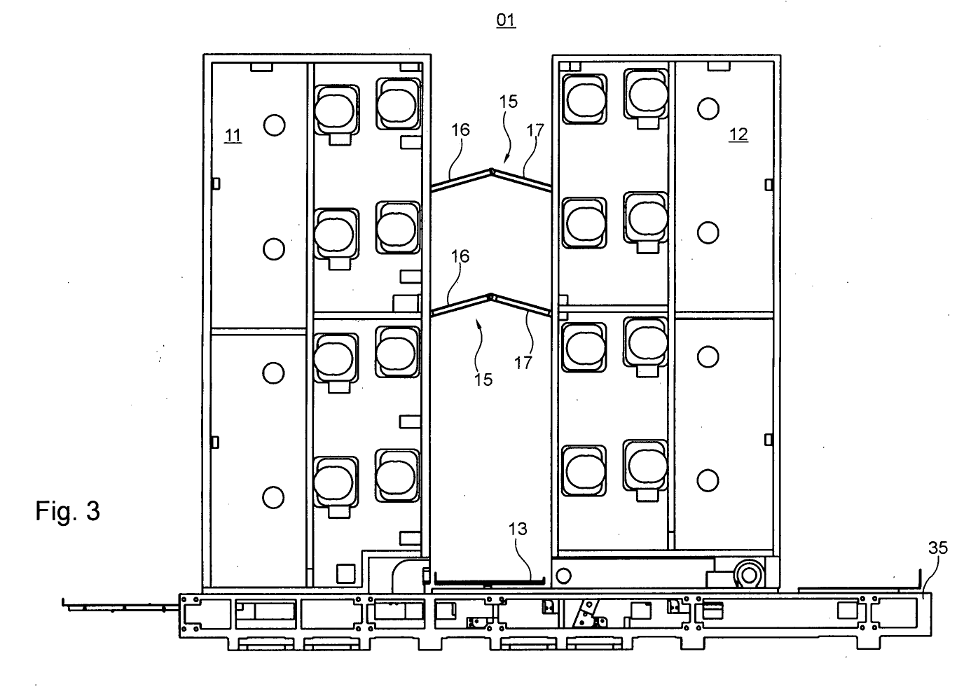

A printing tower 01 in accordance with the present invention, which is shown from a side elevation view in FIG. 1, consists substantially of two side frames or two side frame assemblies 11; 12, a spacing distance between which two side frames or side frame assembles 11; 12 can be adjusted in a horizontal direction. Each printing tower is depicted as accommodating four printing couples 03 or 04, respectively or parts thereof, and arranged one above the other. Each of the printing couples is typically configured including cooperating components such as forme cylinders 02; 14, and especially plate cylinders 02; 14, transfer cylinders 05; 06 and dampening and/or inking units 07; 08. One side frame or side frame assembly 12 can be moved between a functional position, as depicted in FIG. 1, in which the side frames 11; 12 adjoin one another, and an opened position, in which the side frames or side frame assemblies 11; 12 are spaced from one another, as seen, for example in FIG. 3. In the opened position, a passable intermediate space is formed between the two side frames or side frame assemblies 11; 12.

A lifting platform 09; 10 is preferably provided on each of the two exterior sides of the printing tower 01. Each such exterior lifting platform 09; 10 is usable for transporting operating technicians to different heights of the exterior sides of the printing tower 01, with those different exterior heights corresponding to the different heights at which printing couples 03; 04 are arranged. Another, interior lifting platform 13 is provided, which interior lifting platform 13 is arranged between the two side frames 11; 12 when these two side frames 11; 12 are in the horizontally spaced, opened position as depicted schematically in FIG. 3. All of the lifting platforms 09; 10; 13 enable optimal servicing, such as the installation of plates and the performance of maintenance and cleaning work, to be performed from an ergonomic position.

The printing tower 01 is configured as a 4-couple printing tower or as an 8-couple printing tower, as depicted in FIG. 1, and typically operates using an offset printing process. The printing couples 03; 04 of the printing tower 01, each of which are arranged one above the other, are embodied as blanket-to-blanket printing couples 46. The printing tower 01 can be opened up to the configuration shown in FIG. 3 by the provision of the side frames or side frame assemblies 11; 12 being supported for movement to accomplish adjustable spacing, substantially along at least the plane in which the transfer cylinders 05; 06 of the blanket-to-blanket printing couples 46 are in contact with one another. The printing tower 01, which is intended primarily for newspaper printing, is four printing formes in width, and is preferably configured as a 4/2 printing unit. The printing tower 01 can also be six printing formes in width, in which case it is preferably configured as a 6/2 printing unit. It is also possible for the printing tower to be configured as a 4/1 or as a 5/2 printing unit.

In each side frame or side frame assembly 11; 12, multiple, and preferably 4, printing couples 03; 04 are arranged one above the other. Each printing couple 03; 04 preferably has at least one forme cylinder 02; 14, one transfer cylinder 05; 06 and one inking unit 07; 08. A dampening unit may also be provided for each such printing couple. Every two cooperating printing couples 03; 04, which are situated opposite to one another horizontally, form a blanket-to-blanket printing couple 46 which prints both sides of a web simultaneously.

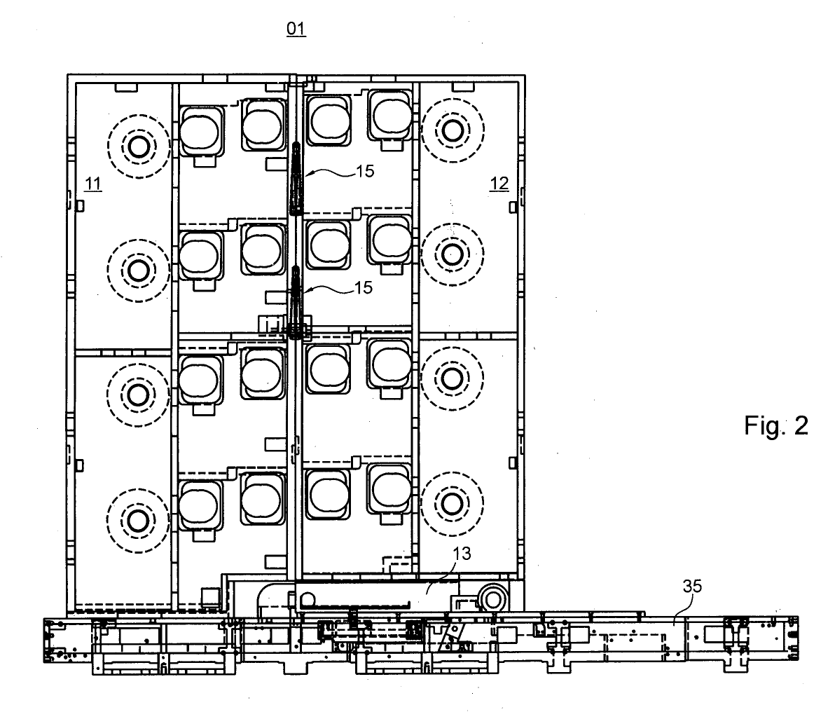

The arrangement of the interior lifting platform 13, which is situated between the two side frames or side frame assemblies 11; 12 when these two side frame assemblies 11; 12 are in the opened position depicted in FIG. 3, will be described in detail in reference to FIG. 2 through FIG. 5. The printing tower 01, with the interior lifting platform 13, is illustrated, simplified in FIGS. 2 through 5 to the extent that inking units 07; 08 and/or dampening units, and plate cylinders 02; 14 and transfer cylinders 05; 06 of the printing couples 03; 04, along with the lifting platforms 09; 10, which are situated on the two exterior sides of the printing tower 01, are not shown.

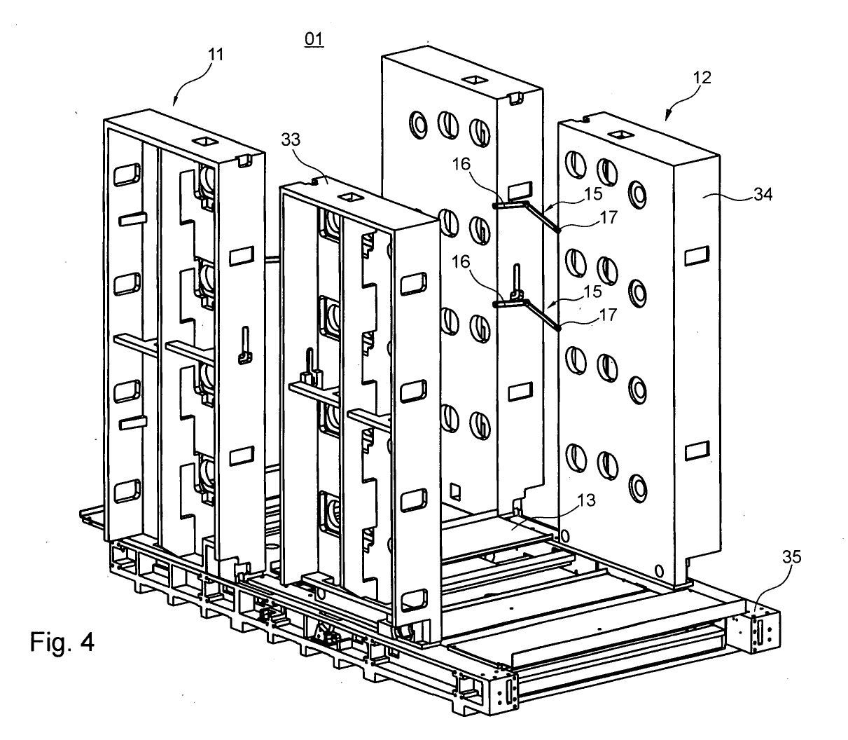

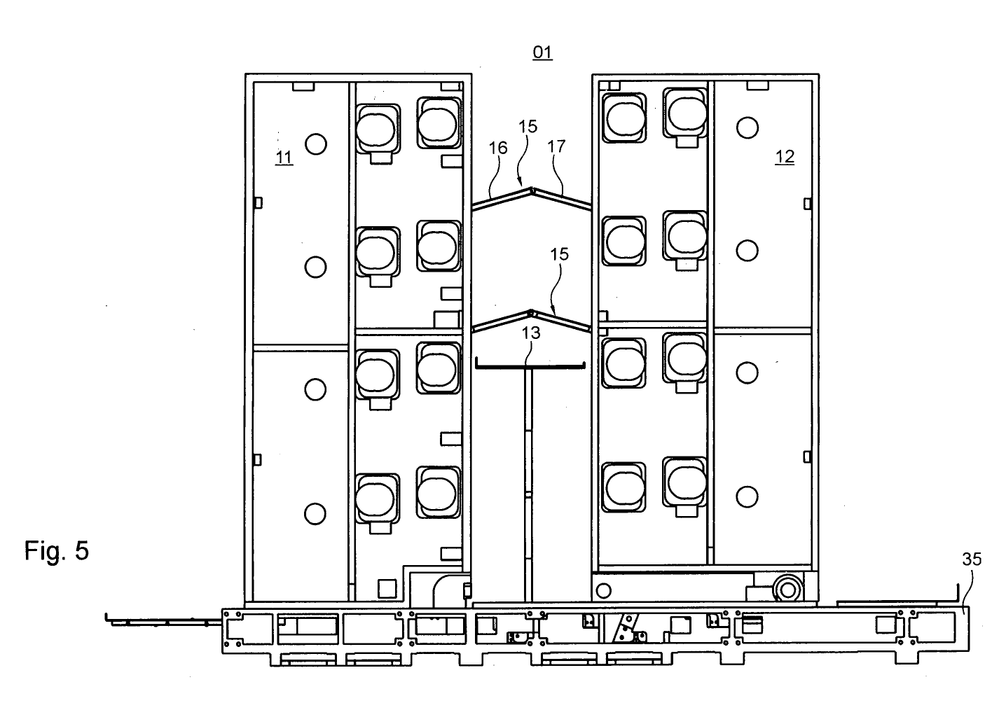

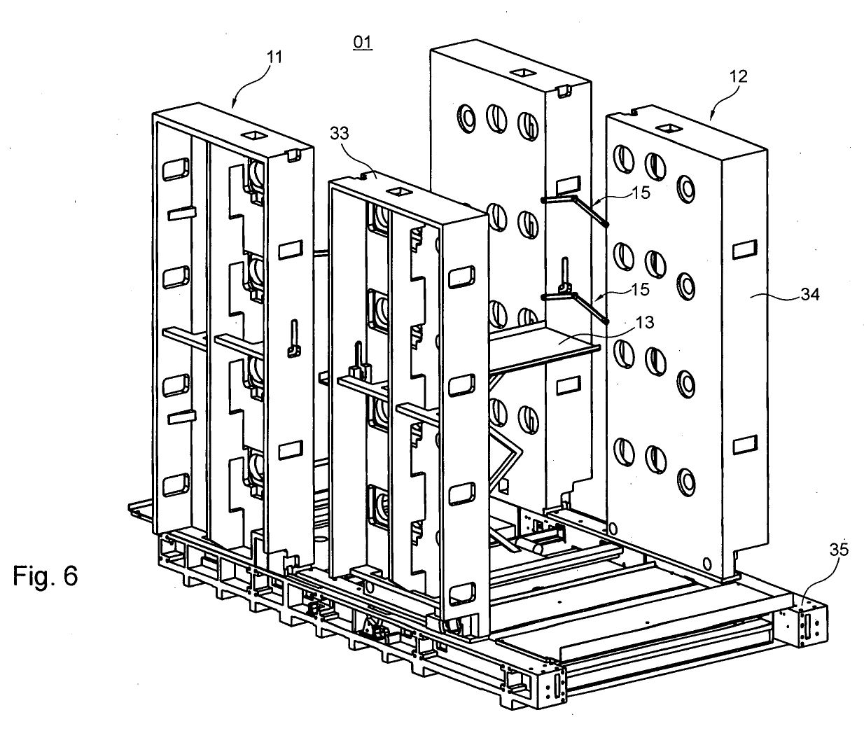

In FIG. 2, the two side frames or side frame assemblies 11; 12, which are configured with adjustable horizontal spacing, are in their functional position. The transfer cylinders 05; 06 of the cooperating printing couples 03; 04, as may be seen in FIG. 1, are, or can be in contact with one another along a plane of contact, and especially with a web of print material, which is not specifically depicted, being situated between them. In FIG. 3 through 6, the two side frames or side frame assemblies 11; 12 with adjustable spacing are depicted in their opened position. The interior lifting platform 13 can be raised from its idle, lowered position, as seen in FIGS. 3 and 4, to at least one elevated, working position of a defined height, as seen in FIG. 5 and FIG. 6, between the transfer cylinders 05; 06 of the printing couples 03; 04. In the opened position of the side frame assemblies, the transfer cylinders 05; 06 of the printing couples 03; 04 are no longer in contact with one another, but are instead separated horizontally from one another. The two side frames or side frame assemblies 11; 12 are both arranged on a common substructure 35. In the configuration depicted in FIGS. 2-6, the side frame assembly 11 is stationary in relation to the substructure 35, while the side frame assembly 12 is movable in relation to the substructure 35. The interior lifting platform 13 can be lowered to a bottom, idle position, in which the opened side frames or side frame assemblies 11; 12 can be moved to their closed, functional position depicted in FIGS. 1 and 2. In this closed, functional position of the printing tower 01, the lifting platform 13 is situated in its bottom, idle position, outside of the area of motion of the movable side frame 12. In its idle position seen in FIG. 2, the interior lifting platform 13 is preferably situated outside of the area of motion of the movable side frame 12 such that it is located below the movable side frame 12. In its idle position, the interior lifting platform 13 can also preferably be situated between the two opposing side frame sections 33; 34 of the movable side frame assembly 12, as seen in FIG. 4. The interior lifting platform 13, in the bottom, idle position, is preferably situated below a lowest printing couple 03; 04, and is especially situated below a transfer cylinder 05; 06 and/or a forme cylinder 02; 14 of a lowest printing couple 03; 04. Viewed in a horizontal direction, the lifting platform 13 is stationary. In other words, it does not move along the substructure 35 in the direction of horizontal movement of the side frame assembly 12.

From a top plan view, the lifting platform 13 and the printing couple 04 and/or the transfer cylinder 06 and/or the forme cylinder 14 overlap one another in a horizontal direction.

In addition, in FIG. 2, in which the two adjustable-spacing side frames or side frame assemblies 11; 12 of the printing tower 01 are in their functional position, and in FIG. 3 through 6, in which the two adjustable-spacing side frames or side frame assemblies 11; 12 of the printing tower 01 are in their horizontally opened position, at least one safety device 15, such as, for example, a guard rail section 15, is preferably assigned to the lifting platform 13. Guard rail section 15 is arranged, for example, on at least one side frame or side frame assembly 11; 12, as a safety measure and is usable primarily to protect operating technicians from falling off of the lifting platform 13 in its raised, working position. In the depicted configuration, the at least one guard rail section 15 is held on, and is connected at its two ends, to the two adjacent side frames or side frame assemblies 11; 12. By moving the two adjacent side frames or side frame assemblies 11; 12 relative to one another, the at least one guard rail section 15 can be moved to its idle position, as seen in FIG. 2, or to its functional position, as seen in FIG. 3 through FIG. 6. The at least one guard rail section 15 can thus be moved, by a relative movement of the two adjacent side frames or side frame assemblies 11; 12, from an at least substantially stowed, idle position to a functional position in which it is extended in relation to the side frames.

At least one safety device 15, which is preferably configured as a guard rail section 15, is located in the printing tower 01, and forms a boundary around the passable intermediate space between the two side frames 11; 12 when the two side frames or side frame assemblies 11; 12 are in their opened position. The safety device 15 is situated so as to form or define a boundary around the intermediate space in the longitudinal direction of a transfer cylinder 05; 06. Preferably, at least one safety device 15 is arranged on each of the two sides of the intermediate space.

Each guard rail section 15 is comprised of two pin-jointed pivoting pieces 16; 17 which are joined to each other at their adjoining, inboard ends. Each pivoting piece 16; 17 of each guard rail section 15 also has an outboard end, one of which is pivotably mounted on one of the two side frames 11, while the other of which is pivotably mounted on the other of the two side frames 12, all as seen in FIG. 3 through FIG. 6. In principle, it is conceivable for the guard rail section 15 to be comprised of more than two of the pin-jointed pivoting pieces 16; 17. The pin-jointed pivoting pieces 16; 17, which form the guard rail section 15, are embodied as rods 16; 17. Two straight lines, each of which extends through the respective frame-side pivoting axis of one of the pivoting pieces 16; 17 and through the shared pivoting axis of the pivoting pieces 16; 17, together form a downward opening angle that is smaller than 180° in both the idle position of the guard rail section 15, as depicted in FIG. 2 and in the functional position of the guard rail section 15, as shown in FIGS. 3-6.

Depending upon the height of the printing tower 01, the number of printing couples 03; 04 which are arranged one above the other, and the number of elevated working positions of defined height for the interior lifting platform 13, at least two guard rail sections 15 are provided, and are arranged spaced one above the other, between the side frames or side frame assemblies 11; 12.

The interior lifting platform 13, which is arranged between the side frames or side frame assemblies 11; 12 in their opened position, has at least one elevated working position of defined height in addition to a bottom, idle position. Accordingly, the vertical positions of the guard rails sections 15 are preferably assigned to the respective working positions of defined height.

It is also conceivable, in principle, for the interior lifting platform 13 to have only one working position of a defined height. This one elevated working position of the interior lifting platform 13 can be assigned two guard rail sections 15, which are arranged one above the other.

As an additional safety measure, the interior lifting platform 13 can also be equipped with at least one emergency shut-off button. The actuation of this emergency shut-off button will halt the vertical movement of the lifting platform 13, thereby holding the lifting platform 13 in its current position, regardless of whether this current position is a working position or an idle position, or any position between these. An emergency shut-off button can be located on one of the guard rail sections 15 or can be located on all guard rail sections 15, and/or can be located on the lifting platform 13 itself. To protect technicians from getting caught in the machinery, a switching strip, preferably in the form of a foot-actuated switch, which is not specifically depicted, can also be mounted on the lifting platform 13, such as, for example, around its perimeter. Such a foot-actuated switch will halt the movement of the lifting platform 13 in a manner similar to, or the same as the emergency shut-off button, for example when it is touched by a foot of the operator. Additionally, a safety plate can be arranged on the underside of the lifting platform 13. Such a safety plate will halt the movement of the interior lifting platform 13, similar to, or in the same manner as the emergency shut-off button, if, during lowering of the lifting platform 13, the safety plate comes into contact with an object underneath the lifting platform 13. Such an object could become damaged or pinned by the lifting platform 13, or could be a person who could be injured by the continued lowering of the lifting platform 13.

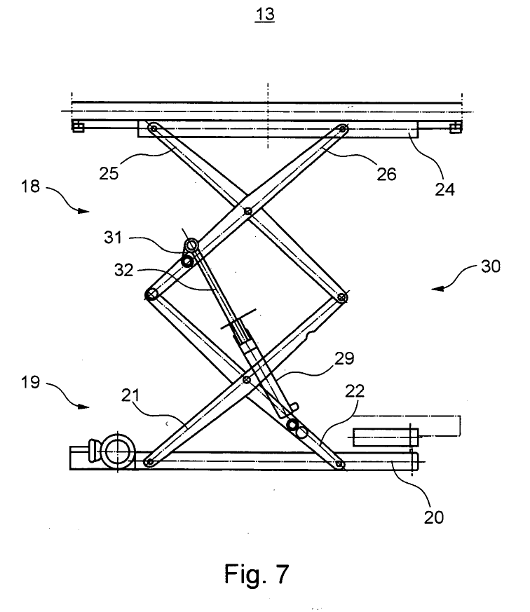

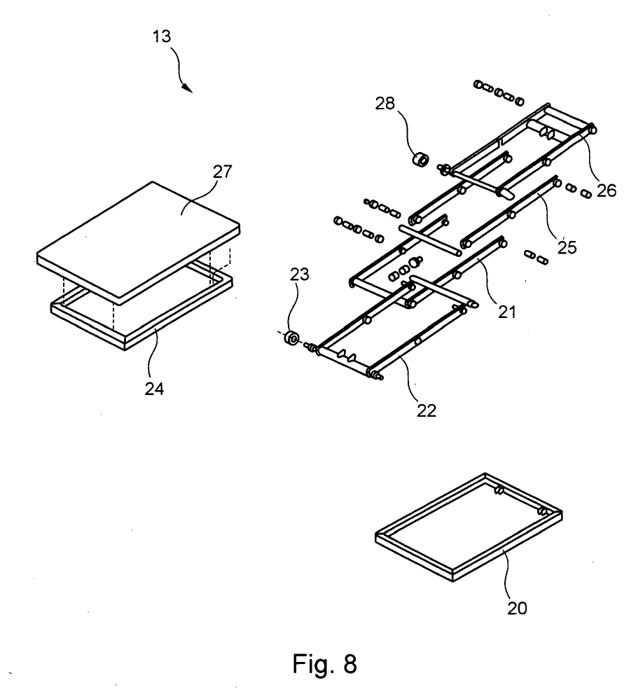

The interior lifting platform 13 is preferably configured as a scissor lift 13, as represented most clearly in FIG. 7 and in FIG. 8. The scissor lift 13 preferably comprises two scissors 18; 19 or pairs of scissors 18; 19, which are pin-jointed to one another. The scissor lift 13 further comprises a lower frame 20, on which a first, lower arm 21 of a lower scissor 19 or a lower pair of scissors 19 is pivotably mounted. The second, other lower arm 22 of the lower scissor 19 or lower pair of scissors 19 is displaceably guided on the lower frame 20. For this purpose, the second, other arm 22 of the lower scissor 19 or lower pair of scissors 19 is preferably equipped with track rollers 23. The scissor lift 13 further comprises an upper frame 24, on which a first, upper arm 25 of an upper scissor 18 or an upper pair of scissors 18 is pivotably mounted. The second, other upper arm 26 of the upper scissor 18 or the upper pair of scissors 18 is displaceably guided on the upper frame 24. For this purpose, the second, other upper arm 26 of the upper scissor 18 or the upper pair of scissors 18 is preferably equipped with track rollers 28. The upper frame 24 also has an upper platform 27.

At least one actuation assembly 29, such as, for example, a cylinder 29, is provided for use in moving the lifting platform 13. The cylinder 29 is preferably configured as a lift cylinder 29. The lift cylinder 29 is preferably functionally situated between two pin-jointed ends of the arms 22; 26 of the scissor assembly 30 of the scissor lift 13, which scissor assembly 30 is comprised of the lower scissors 19 and the upper scissors 18 or of the scissor pairs 19 and 18. In this case, the lift cylinder 29 is functionally arranged between the two pin-jointed arms 22; 26 of the two different scissors 19; 18 or scissor pairs 19; 18 of the scissor arrangement 30. In principle, it is also conceivable for the cylinder 29 to be functionally arranged between two pin-jointed arms 21; 22 or 25; 26 of a scissor 19 or 18 or of a scissor pair 19 or 18 of the scissor assembly 30.

Preferably, a single lift cylinder 29 is provided, and is arranged centrally between the scissor pairs 18; 19 of the scissor assembly 30.

At least one end of the lift cylinder 29 is preferably pivotably mounted on a pivoting lever 31, as seen in FIG. 7. Preferably, the lift cylinder 29 is pivotably mounted, at one end, on the lower or bottom scissor 19, with the piston rod 32 of the lift cylinder 29, at its opposite end, being pivotably mounted on the upper scissor 18. In this case, the end of the piston rod 32 is preferably mounted on the pivoting lever 31, which is, in turn, pivotably mounted on the upper scissor 18. The at least one lift cylinder 29 is preferably embodied as a hydraulic cylinder 29.

It is important to emphasize that the exterior lifting platforms 09; 10 can also be embodied as scissor lifts which would be generally similar to the scissors lift assembly 30 utilized to raise and lower the interior lifting platform 13.

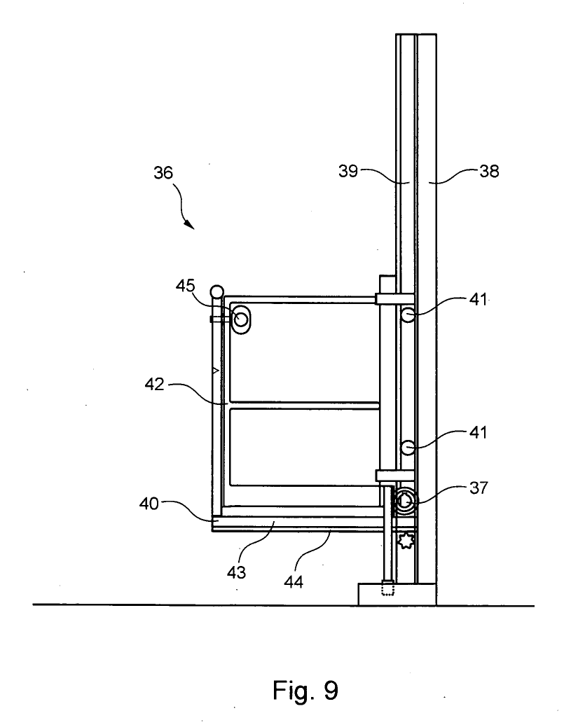

Each of the lifting platforms 09 and 10, which are arranged on the exterior sides of the printing tower 01, and the interior lifting platform 13, which is arranged between the two side frames or side frame assemblies 11; 12 of the printing tower 01, when they are in their opened position, can also be embodied as an elevator 36, which is provided with a rack-and-pinion drive or lift cylinder drive, as is represented in FIG. 9, rather than as a scissor lift. Each elevator platform can be guided on a guide track 39 or between multiple guide tracks 39. The elevator 36 depicted in FIG. 9 has a platform 40, the vertical movement of which platform 40 is guided by the operation of track rollers 41 that engage in one or more vertical guide tracks 39. In the case of a rack-and-pinion drive for the elevator platform 40, a pinion 37 of a drive motor engages in a toothed rack 38. When the drive motor is actuated, the motor-driven pinion 37 generates a linear relative movement between the toothed rack 38 and the drive motor. All other suitable types of linear drives, such as a hydraulic cylinder which forces the platform 40 upward in the manner of a ram, are also conceivable drive options for the elevator 36. In this case, a toothed rack 38 can assume the function of a guide track 39, or vice versa. The at least one guide track 39 or the at least one toothed rack 38 is then preferably arranged on the stationary side frame or side frame assembly 11. Preferably, no guide track 39 or toothed rack 38, respectively, is arranged on the movable side frame 12.

A guard rail 42 is provided as a safety feature that is intended to prevent falls. This guard rail is provided in connection with the use of the elevator 36 as one of the lifting platforms 09 or 10 which arranged on the exterior sides of the side frames or side frame assemblies 11; 12. As an additional safety measure, the elevator 36 can be equipped with at least one emergency shut-off button 45. The actuation of such a shut-off button 45 will halt the vertical movement of the elevator 36 and will hold the elevator 36 in its current position. Such a stoppage will occur regardless of whether this current position of the elevator 36 is a working position, an idle position, or any position between these two. The emergency shut-off button 45 can be located on the guard rail 42. In an embodiment of the elevator 36 without a guard rail 42, particularly if the elevator 36 is to be used as a lifting platform 13 which is arranged between the two side frames or side frame assemblies 11; 12 in their opened position, the emergency shut-off button 45 can be located on one or on all of the guard rail sections 15, and/or can be positioned on the elevator 36 itself.

To protect technicians from getting caught in the machinery, a switching strip 43, preferably in the form of a foot-actuated switch 43, can be mounted on the elevator 36, for example around its perimeter. Such a foot-actuated switch 43 will halt the movement of the elevator 36 in a manner which is similar to, or the same as the emergency shut-off button 45, for example when touched by a foot. Additionally, a safety plate 44 can be arranged on the underside of the elevator 36. This safety plate 44 will halt the movement of the elevator 36 in a manner which is similar to or the same as the emergency shut-off button 45. If, during lowering of the elevator 36, the safety plate 44 comes into contact with an object underneath the elevator 36, such as an object that could become damaged or pinned by the elevator 36, or a person who could be injured by the continued lowering of the elevator 36, the safety plate 44 will stop further movement of the elevator 36.

While preferred embodiments of printing towers with at least two printing couples arranged one above the other, and a method for operating such a printing tower, in accordance with the present invention, have been set forth fully and completely hereinabove, it will become apparent to one of skill in the art that various changes in, for example the specific structure of the inking and dampening units, the nature of the web to be printed and the overall structure of a printing press in which such printing towers could be utilized, could be made without departing from the true spirit and scope of the present invention which is accordingly to be limited only by the appended claims.

What is claimed is:

1-69. (canceled)

70. A printing tower comprising:
a first side frame assembly;
at least first and second printing couples arranged above one another in said first side frame assembly;
a second side frame assembly;
at least third and fourth printing couples arranged above one another in said second side frame assembly;
means supporting at least one of said first and second side frame assemblies for movement in a horizontal direction with respect to the other of said first and second side frame assemblies between a closed, functional position in which said at least first and second printing couples are in cooperative printing engagement with said at least third and fourth printing couples, and an opened position in which said first and second frame assemblies are spaced from each other;
a lifting platform positioned between said first and second side frame assemblies; and
means supporting said lifting platform for movement between a raised, work position between said first and second side frame assemblies in said opened position and a lowered, idle position when said first and second side frame assemblies are in said closed, functional position.

71. The printing tower or claim 70 wherein one of said at least first and second printing couples and one of said third and fourth printing couples is a lowest printing couple in its respective one of said first and second side frame assemblies and further wherein, in said lowered position, said lifting platform is positioned below said lowest printing couple of each of said first and second side frame assemblies.

72. The printing tower of claim 71 wherein each of said lowest ones of said printing couples includes a transfer cylinder and a forme cylinder and further wherein said lifting platform, in said lowered position, is positioned below one of said transfer cylinder and said forme cylinder of said lowest ones of said printing couples in said first and second side frame assemblies.

73. The printing tower of claim 71 wherein each of said lowest ones of said printing couples includes a transfer cylinder and a forme cylinder and further wherein said lifting platform, in said lowered position overlaps one of said transfer cylinders and said frame cylinders of said lowest ones of said printing couples in a horizontal direction.

74. The printing tower of claim 70 wherein said lifting platform is stationary in said horizontal direction.

75. The printing tower of claim 70 wherein said lifting platform, in said lowered, idle position, is outside of an area of movement of said movable one of said first and second side frame assemblies.

76. The printing tower of claim 70 wherein said lifting tower is below said movable side frame assemble in said lowered, idle position.

77. The printing tower of claim 70 wherein lifting platform, in said lowered, idle position is between two opposing side frame positions of said movable side frame assembly.

78. The printing tower of claim 70 wherein said lifting platform is a scissors lift.

79. The printing tower of claim 78 wherein said scissors lift is comprised of first and second pin-jointed scissor pairs.

80. The printing tower of claim 79 wherein said scissor lift includes a lower platform on which a first lower arm of said first scissor pair is pivotably mounted.

81. The printing tower of claim 80 wherein a second lower arm of said first scissor pair is displaceably guided in said lower platform.

82. The printing tower of claim 81 wherein said second lower arm of said first scissor pair is equipped with track rollers.

83. The printing tower of claim 79 wherein said scissor lift further includes an upper frame on which a first upper arm of said second scissor pair is pivotably mounted.

84. The printing tower of claim 83 wherein a second upper arm of said second scissor pair is displaceably guided on said upper frame.

85. The printing tower of claim 84 wherein said second upper arm of said second scissors pair is equipped with track rollers.

86. The printing tower of claim 83 wherein said upper frame supports a platform.

87. The printing tower of claim 70 wherein said means supporting said lifting platform includes at least one actuation drive.

88. The printing tower of claim 87 wherein said actuation drive is a cylinder.

89. The printing tower of claim 88 wherein said cylinder is a lift cylinder.

90. The printing tower of claim 89 wherein said lifting platform is a scissors lift comprised of first and second pin-jointed scissor pairs and further wherein said cylinder is functionally arranged between first and second pin-jointed arms of one of said first and second scissors pair.

91. The printing tower of claim 90 wherein said cylinder is functionally arranged between first and second pin-jointed arms of both of said first and second scissors pairs.

92. The printing tower of claim 79 further including a single lifting cylinder centrally arranged between said first and second pin-jointed scissor pairs.

93. The printing tower of claim 92 further including a pivoting lever between said first and second pin-jointed scissor pairs and wherein said single lifting cylinder has an end connected to said pivoting lever.

94. The printing tower of claim 90 wherein one end of said cylinder is mounted on said first scissor pair and a second end of said cylinder is mounted on said second scissor pair.

95. The printing tower of claim 93 wherein said pivoting lever is pivotably mounted on an upper one of said first and second scissor pairs.

96. The printing tower of claim 88 wherein said cylinder is a hydraulic cylinder.

97. The printing tower of claim 90 wherein said lifting platform is an elevator which is guided by at least one guide track.

98. The printing tower of claim 97 further including track rollers on said elevator and wherein said elevator is movable vertically by engagement of said track rollers in said at least one guide track.

99. The printing tower of claim 97 wherein said elevator has one of a rack-and-pinion drive and a lift cylinder drive.

100. The printing tower of claim 99 further including a drive motor for said rack-and-pinion drive and a pinion driven by said drive motor and further including a toothed guide track engageable by said pinion.

101. The printing tower of claim 100 wherein said toothed rack functions as said guide track.

102. The printing tower of claim 101 wherein said toothed rack is arranged in a stationary one of said first and second side frame assemblies.

103. The printing tower of claim 70 further including an emergency shut-off button associated with said lifting platform and usable, upon actuation, to halt vertical movement of said lifting platform.

104. The printing tower of claim 70 wherein said lifting platform includes a switching strip.

105. The printing tower of claim 70 wherein said lifting platform includes a safety plate.

106. A printing tower comprising:
a first side frame assembly;
at least first and second printing couples arranged one above the other in said first side frame assembly;
a second side frame assembly;
at least third and fourth printing couples arranged one above the other in said second side frame assembly;
means supporting at least one of said first and second side frame assemblies for movement in a horizontal direction with respect to the other of said first and second side frame assemblies between a closed, functional position in which said at least first and second printing couples are in cooperative printing equipment with said third and fourth printing couples, and an opened position in which said first and second printing couples are spaced from said third and fourth printing couples;
at least one lifting platform; and
at least one safety device associated with said first and second frame assemblies and usable to form a boundary around a passable space between said first and second frame assemblies in said opened position.

107. The printing tower of claim 70 further including at least one safety device adapted to form a boundary around a passable space between said first side frame assembly and said second side frame assembly in said opened position.

108. The printing tower of claim 107 further wherein each of said at least first, second, third and fourth printing couples each includes a transfer cylinder, each said transfer cylinder having a longitudinal axial direction, said passable space being defined by an intermediate space between said transfer cylinders.

109. The printing tower of claim 108 wherein there are first and second safety devices located at first and second sides of said intermediate space.

110. The printing tower of claim 107 wherein said at least one safety device is a guard rail section.

111. The printing tower of claim 107 wherein said at least one safety device is arranged on at least one of said first and second side frame assemblies.

112. The printing tower of claim 107 wherein said at least one safety device is held on said first and second side frame assemblies.

113. The printing tower of claim 112 wherein said movement of one said side frame assemblies with respect to the other of said side frame assemblies moves said at least one safety device between an idle position and a functional position.

114. The printing tower of claim 113 wherein said at least one safety device is extended on said functional position.

115. The printing tower of claim 110 wherein said at least one guard rail section includes first and second pin-jointed pivoting members, a first one of said pin-jointed members being pivotably mounted at a first end to said first side frame assembly, a second said pin-jointed pivoting members being connected at a first end to said second side frame assembly.

116. The printing tower of claim 110 wherein said guard rail section has first and second pivoting pieces.

117. The printing tower of claim 115 wherein said first and second pin-jointed pivoting members are rods.

118. The printing tower of claim 115 wherein each of said pivoting members defines a straight line and further wherein an intersection of said straight lines defines a downward opening angle of less than 180°.

119. The printing tower of claim 110 further including at least two of said guard rail sections arranged one above the other.

120. The printing tower of claim 107 further including at least one elevating working position of defined height for said at least one lifting platform.

121. The printing tower of claim 120 wherein a vertical position of said at least one safety device is assigned to said elevated working position for said at least one lifting platform.

122. The printing tower of claim 121 wherein said at least one working platform has one said elevated working position of defined height and further including two of said safety devices which are assigned to said elevated working position.

123. The printing tower of claim 70 further including a second lifting platform provided on an exterior of one of said first and second side frame assemblies.

124. The printing tower of claim 123 further including a third lifting platform provided on an exterior surface of the other of said first and second side frame assemblies.

125. The printing tower of claim 70 where there are only said first and second side frame assemblies in said printing tower.

126. The printing tower of claim 70 wherein one of said first and second side frame assemblies is stationary.

127. The printing tower of claim 70 wherein each of said first, second, third and fourth printing couples are blanket-to-blanket printing units including transfer cylinders.

128. The printing tower of claim 127 further including a plane of division of said printing tower defined by points of contact of said transfer cylinders of said blanket-to-blanket printing couples.

129. The printing tower of claim 70 further including fifth and sixth printing couples in said first side frame assembly and seventh and eighth printing couples in said second side frame assembly, all of said printing couples in each of said side frame assemblies being arranged one above the other.

130. The printing tower of claim 70 wherein said printing tower is configured for newspaper printing.

131. The printing tower of claim 70 wherein said printing tower is four printing formes in width.

132. The printing tower of claim 131 wherein said printing tower is a 4/2 printing unit.

133. The printing tower of claim 70 wherein said printing tower is six printing formes in width.

134. The printing tower of claim 133 wherein said printing tower is a 6/2 printing unit.

135. The printing tower of claim 70 where each printing tower is an offset printing unit.

136. The printing tower of claim 70 wherein each said printing couple includes a transfer cylinder, a forme cylinder and an inking unit.

137. A method for operating a printing tower including:
providing a first side frame assembly;
providing first and second printing couples arranged one above the other in said first side frame assembly;
providing a second side frame assembly;
providing third and fourth printing couples arranged one above the other in said second side frame assembly;
supporting at least one of said first and second side frame assemblies for movement in a horizontal direction, with respect to the other of said first and second side frame assemblies, between a functional position in which said first and second side frame assemblies are adjoining each other and an opened position in which said first and second side frame assemblies are spaced apart from one another;
providing a lifting platform between said first and second side frame assemblies;
elevating said lifting platform between said first and second side frame assemblies into an elevated work position where said first and second side frame assemblies are in said opened position;
lowering said lifting platform to a bottom, idle position;
providing a lowest transfer cylinder in at least a movable one of said first and second side frame assemblies; and
providing said bottom, idle position of said lifting platform beneath said lowered transfer cylinder where said movable side frame assembly is moved from said open position to said functional position.
